(19) United States
(12) Patent Application Publication
(10) Pub. No.: US 2022/0392204 A1
(43) Pub. Date: Dec. 8, 2022

(54) METHOD OF TRAINING MODEL, ELECTRONIC DEVICE, AND READABLE STORAGE MEDIUM

(71) Applicant: BEIJING BAIDU NETCOM SCIENCE TECHNOLOGY CO., LTD., Haidian District (CN)

(72) Inventors: Wei ZHANG, Beijing (CN); Xiao TAN, Beijing (CN); Hao SUN, Beijing (CN)

(73) Assignee: BEIJING BAIDU NETCOM SCIENCE TECHNOLOGY CO., LTD., Haidian District (CN)

(21) Appl. No.: 17/891,381

(22) Filed: Aug. 19, 2022

(51) Int. Cl. G06V 10/774; G06V 10/776

(52) U.S. Cl. CPC G06V 10/7747; G06V 10/776

(57) ABSTRACT

A method of training a model, an electronic device, and a readable storage medium are provided, which relate to a field of artificial intelligence, in particular to computer vision and deep learning technologies, and specifically used in smart city and intelligent transportation scenarios. The method includes: determining a target pre-trained model; and performing an unsupervised training and/or a semi-supervised training on the target pre-trained model based on an image acquired by the target terminal, so as to obtain a first target trained model.

### CROSS REFERENCE TO RELATED APPLICATION(S)

This application claims priority to Chinese Patent Application No. 202111052308.7, filed on Sep. 8, 2021, the entire contents of which is incorporated herein in its entirety by reference.

### TECHNICAL FIELD

The present disclosure relates to a field of artificial intelligence, in particular to computer vision and deep learning technologies, which may be specifically used in smart city and intelligent transportation scenarios, and in particular to a method of training a model, an electronic device, and a readable storage medium.

### BACKGROUND

With a development of an artificial intelligence technology, the smart city and intelligent transportation are inseparable from a support of the artificial intelligence technology. How to train an artificial intelligence model in such scenarios has become a problem.

### SUMMARY

The present disclosure provides a method of training a model, an electronic device, and a readable storage medium.

According to an aspect of the present disclosure, there is provided a method of training a model, applied to a target terminal, wherein the method includes: determining a target pre-trained model; and performing an unsupervised training and/or a semi-supervised training on the target pre-trained model based on an image acquired by the target terminal, so as to obtain a first target trained model.

According to an aspect of the present disclosure, there is provided an electronic device, including: at least one processor; and a memory communicatively connected to the at least one processor, wherein the memory stores instructions executable by the at least one processor, and the instructions, when executed by the at least one processor, cause the at least one processor to implement a method described herein.

According to an aspect of the present disclosure, there is provided a non-transitory computer-readable storage medium having computer instructions stored thereon, wherein the computer instructions are configured to cause a computer to implement a method described herein.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 shows a flowchart of a method of training a model according to the present disclosure;

FIG. 2 shows an example diagram of an augmented sample according to the present disclosure;

FIG. 3 shows a structural diagram of an apparatus of training a model according to the present disclosure; and

FIG. 4 shows a block diagram of an electronic device for implementing the embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

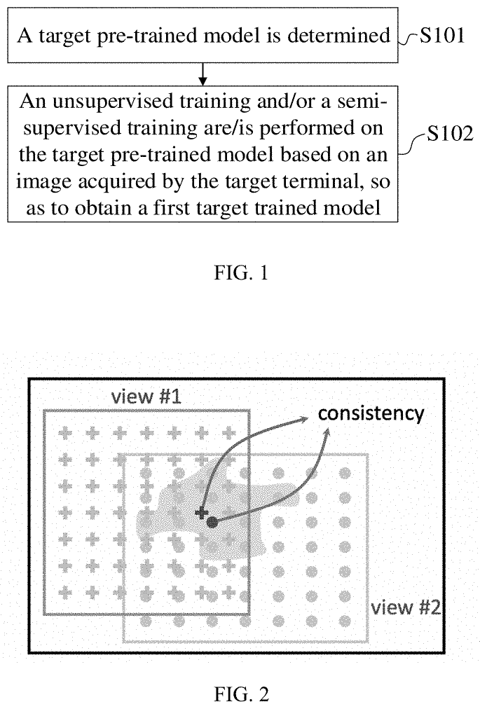

FIG. 1 shows a method of training a model provided by the embodiments of the present disclosure, which is applied to a target terminal. As shown in FIG. 1, the method includes steps S101 and S102.

In step S101, a target pre-trained model is determined.

Specifically, the target pre-trained model may be a model well trained on a server side. After the target pre-trained model is well trained on the server side, the server may transmit the target pre-trained model to a target terminal device. One or more target terminal devices may be provided. In this case, after the target pre-trained model is well trained by the server, the server may transmit the target pre-trained model to various target terminal devices, and each of the target terminal devices receives the same target pre-trained model.

In step S102, an unsupervised training and/or a semi-supervised training are/is performed on the target pre-trained model based on an image acquired by the target terminal, so as to obtain a first target trained model.

The target terminal device may be a vehicle-mounted device deployed on a vehicle or a corresponding smart camera on a traffic road. The vehicle-mounted device or smart camera has a certain computing power and may retrain the target pre-trained model according to the image acquired by them, so as to obtain the corresponding first target trained model.

Machine learning may roughly include supervised learning, unsupervised learning, and semi-supervised learning. The supervised learning refers to that each sample in training data has a label, and a model may be guided by the label to learn a discriminative feature, so as to predict an unknown sample. The unsupervised learning refers to that the training data has no label, and a constraint relationship between some data, such as an association and a distance relationship between data, may be obtained from the data through an algorithm. An existing unsupervised algorithm, such as clustering, may cluster samples close to each other (or similar samples) according to a certain metric. The semi-supervised learning refers to a learning manner between the supervised learning and the unsupervised learning, in which the training data includes both labeled data and unlabeled data.

The learning manner adopted by the target terminal device of the present disclosure includes the unsupervised learning and/or the semi-supervised learning, so that the target pre-trained model may be retrained without using a large amount of labeled data. Whether to adopt the unsupervised learning, the semi-supervised learning, or both the unsupervised learning and the semi-supervised learning to retrain the target pre-trained model may be determined according to the application scenario of the target terminal device.

Different from a related art in which a model is trained well on a server side and then deployed to various terminal devices for application so that the model actual applied at each of the terminal devices is the same, the solution provided by the embodiments of the present disclosure is implemented to determine a target pre-trained model and perform an unsupervised training and/or a semi-supervised training on the target pre-trained model based on an image acquired by the target terminal, so as to obtain a first target trained model. That is, the unsupervised training and/or the semi-supervised training are/is performed on the target pre-trained model deployed at the target terminal based on the image acquired by the target terminal, so as to obtain the first target trained model actually applied at the target terminal. Therefore, models actually applied at various target terminals are different, where each of the models is trained by using corresponding images acquired by a corresponding target terminal, so that an accuracy of a model prediction performed by the model deployed at each target terminal for a corresponding application scenario of the each target terminal may be improved.

The embodiments of the present disclosure provide an implementation, in which the target pre-trained model is trained based on images acquired by a plurality of terminals, and at least some of the terminals are deployed in different regions respectively. The target terminal is located in a predetermined region

Specifically, the target pre-trained model may be trained by images acquired by terminal devices located in different predetermined regions, and the target terminal device may be located in a predetermined region. The model may be pre-trained using the images acquired by the target terminal devices located in different regions in a predetermined scene, and then retrained based on an image acquired by a specific target terminal in the predetermined region, so as to improve a training speed while ensuring an accuracy of the target trained model adopted by the target terminal.

For example, the target terminal device may be a smart camera located at a specific traffic intersection. Specifically, in a smart traffic scenario, a corresponding number of smart cameras are deployed in a traffic region. The smart cameras are located in different regions, and models deployed on respective cameras have different prediction tasks. Even in a case of the same prediction task, due to different specific scenes of the regions where the smart cameras are respectively located, if the various smart cameras use the same model, there may be a problem of insufficient generalization, that is, the accuracy of model prediction is poor for specific scenes of some regions. In the present disclosure, the target pre-trained model is trained using the images acquired by a plurality of terminals located in different regions and then retrained according to the image acquired by the target terminal in the predetermined region, so as to obtain the first target trained model. Then, the target terminal device performs a corresponding prediction based on the first target trained model, so that the accuracy of the model prediction performed by the target terminal device in the predetermined region where the target terminal device is located may be improved.

The embodiments of the present disclosure provide an implementation, in which a process of training the target pre-trained model includes a pre-training stage and a fine tuning stage.

The pre-training refers to a pre-trained model or a process of pre-training a model. The fine tuning refers to a process of applying the pre-trained model to a specific data set and adapting a parameter to the specific data set. The pre-trained model may be taken as a basic model, and then the basic model may be further adjusted with a specific scenario or typed data set, so as to obtain a model with better performance.

For example, as for functions of the pre-training and the fine tuning, in a field of a computer vision, as a probability of a user acquiring a large enough data set is very small, it is rare to train a neural network from scratch. If the data set is not large enough but a good model is desired, it is easy to cause over fitting. Therefore, a general operation is to train a model on a large data set (such as ImageNet), and then use the model as an initialization or a feature extractor for a similar task. For example, VGG, Inception and other models provide their own training parameters which can be used by the user for a subsequent fine tuning, which may not only save time and computing resources, but also achieve a good result quickly.

For the embodiments of the present disclosure, the process of obtaining the first target trained model may include the pre-training stage and the fine tuning stage at the server side, and a retraining (unsupervised training and/or semi-supervised training) at the target terminal device. After the pre-training stage and the fine tuning stage at the server side, the target terminal device only needs to slightly train the target pre-trained model, and then a model with a better performance and adapted to a prediction task in the predetermined region where the target terminal device is located may be obtained. In addition, the target terminal device does not need to have a strong data computing power, so that a performance requirement of the target terminal device is reduced, which is more conducive to a deployment and application of the model in each target terminal device.

The embodiments of the present disclosure provide an implementation, and in the pre-training stage, a self-supervised training is performed based on a Propagate Yourself algorithm.

Different from constructing a self-supervised training sample set from a full image, a pixel-level self-supervision manner is adopted in the embodiments of the present disclosure, which may more effectively perform the model pre-training for tasks such as object detection, segmentation and tracking. Specifically, a pixel-level self-supervision pre-training method in Propagate Yourself is adopted. In a process of performing a sample augmentation of a training image, an augmentation manner (such as rotation, translation, cropping, etc.) is recorded. In different augmented samples, a sample pair from the same pixel in an original image is a positive example, and a sample pair from different pixels is a negative example. As shown in FIG. 2, view1 and view2 are augmented samples generated through the same image, samples with arrows pointing to a coordinate position are a positive sample pair, and the rest are negative sample pairs.

For the embodiments of the present disclosure, a pixel-level pre-task is effective not only for a pre-training of an existing backbone network, but also for a head network used for intensive downstream tasks, and is a supplement to an example-level comparison method, so as to improve the performance of the target trained model obtained by performing a self-supervised training based on the Propagate Yourself algorithm, then performing fine-tuning, and then retraining at the target terminal.

The embodiments of the present disclosure provide an implementation, in which the method further includes: switching the target terminal from a model prediction mode to a model self-evolution mode, in response to a predetermined switch condition being met; and performing an unsupervised training and/or a semi-supervised training on the first target trained model, so as to obtain a second target trained model.

The predetermined switch condition includes at least one of: the target terminal failing to perform a model prediction under a current light condition; or the target terminal failing to perform a model prediction under a current weather condition. Specifically, the current light condition or weather condition may be determined by a corresponding image analysis, so as to determine whether the target terminal may perform a corresponding model prediction task.

Specifically, the task of the target terminal device mainly includes two aspects, namely a model prediction task and a model training task. The computing resources of the target terminal device are limited, and the model prediction task and model training task may not be both taken into account. How to make full use of the computing resources of the target terminal device and perform the task of the target terminal device has become a problem.

Specifically, when a predetermined condition is met, the target terminal may be switched from the model prediction mode to the model self-evolution mode, in which an unsupervised training and/or a semi-supervised training are/is performed on the first target trained model to obtain the second target trained model, so that the self-evolution of the target trained model may be achieved while taking into account the prediction task of the target terminal device. That is, the first target trained model may be further trained to obtain the second target trained model with better performance. In addition, the second target trained model may be retrained to achieve a self-evolution of the target trained model applied at the target terminal.

Specifically, a current resource utilization status information of the target terminal device may also be determined, and whether to retrain the first target trained model may be determined according to the resource utilization status information.

For the embodiments of the present disclosure, the self-evolution of the target trained model applied at the target terminal device may be achieved with taking into account the model prediction task and the model training task of the target terminal device, so that the performance of the target trained model applied at the target terminal device may be improved.

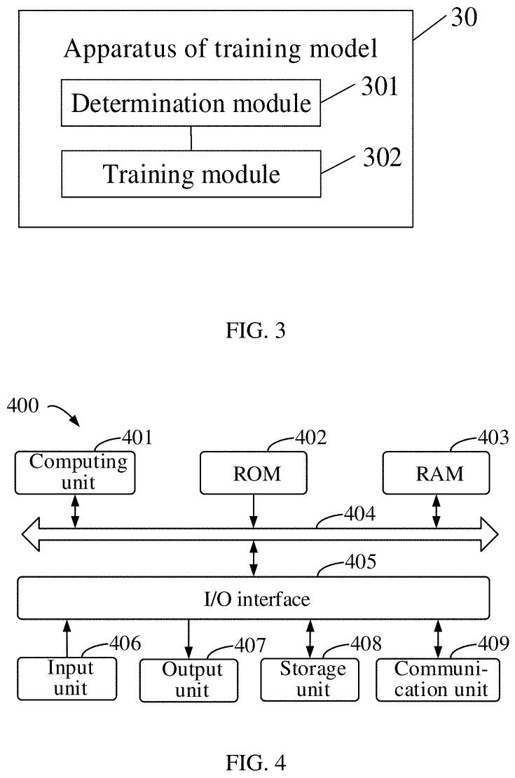

The embodiments of the present disclosure provide an apparatus of training a model, applied to a target terminal. As shown in FIG. 3, the apparatus includes: a determination module 301 used to determine a target pre-trained model; and a training module 302 used to perform an unsupervised training and/or a semi-supervised training on the target pre-trained model based on an image acquired by the target terminal, so as to obtain a first target trained model.

The embodiments of the present disclosure provide an implementation, in which a process of training the target pre-trained model includes a pre-training stage and a fine tuning stage.

The embodiments of the present disclosure provide an implementation, in which the training module is further used to perform a self-supervised training based on a Propagate Yourself algorithm.

The embodiments of the present disclosure provide an implementation, in which the target pre-trained model is trained based on images acquired by a plurality of terminals, and at least some of the terminals are deployed in different regions respectively. The target terminal is located in a predetermined region.

The embodiments of the present disclosure provide an implementation, in which the apparatus further includes: a switching module used to switch the target terminal from a model prediction mode to a model self-evolution mode, in response to a predetermined switch condition being met; and perform an unsupervised training and/or a semi-supervised training on the first target trained model, so as to obtain a second target trained model.

The embodiments of the present disclosure provide an implementation, in which the predetermined switch condition includes at least one of: the target terminal failing to perform a model prediction under a current light condition; or the target terminal failing to perform a model prediction under a current weather condition.

The beneficial effects of the embodiments of the present disclosure are the same as those of the method embodiments described above, which will not be repeated here.

In the technical solution of the present disclosure, the collection, storage, use, processing, transmission, provision, disclosure and application of the user's personal information involved are all in compliance with the provisions of relevant laws and regulations, and necessary confidentiality measures have been taken, and it does not violate public order and good morals. In the technical solution of the present disclosure, before obtaining or collecting the user's personal information, the user's authorization or consent is obtained.

According to the embodiments of the present disclosure, the present disclosure further provides an electronic device, a readable storage medium, and a computer program product.

The electronic device includes: at least one processor; and a memory communicatively connected to the at least one processor. The memory stores instructions executable by the at least one processor, and the instructions, when executed by the at least one processor, cause the at least one processor to perform the method provided by the embodiments of the present disclosure.

Different from a related art in which a model is trained well on a server side and then deployed to various terminal devices for application so that the model actual applied at each of the terminal devices is the same, the electronic device provided by the embodiments of the present disclosure is implemented to determine a target pre-trained model and perform an unsupervised training and/or a semi-supervised training on the target pre-trained model based on an image acquired by the target terminal, so as to obtain a first target trained model. That is, the unsupervised training and/or the semi-supervised training are/is performed on the target pre-trained model deployed at the target terminal based on the image acquired by the target terminal, so as to obtain the first target trained model actually applied at the target terminal. Therefore, models actually applied at various target terminals are different, where each of the models is trained by using corresponding images acquired by a corresponding target terminal, so that an accuracy of a model prediction performed by the model deployed at each target terminal for a corresponding application scenario of the each target terminal may be improved.

The readable storage medium is a non-transitory computer readable storage medium storing computer instructions, and the computer instructions are used to cause a computer to implement the method provided by the embodiments of the present disclosure.

Different from a related art in which a model is trained well on a server side and then deployed to various terminal devices for application so that the model actual applied at each of the terminal devices is the same, the readable storage medium provided by the embodiments of the present disclosure is implemented to determine a target pre-trained model and perform an unsupervised training and/or a semi-supervised training on the target pre-trained model based on an image acquired by the target terminal, so as to obtain a first target trained model. That is, the unsupervised training and/or the semi-supervised training are/is performed on the target pre-trained model deployed at the target terminal based on the image acquired by the target terminal, so as to obtain the first target trained model actually applied at the target terminal. Therefore, models actually applied at various target terminals are different, where each of the models is trained by using corresponding images acquired by a corresponding target terminal, so that an accuracy of a model prediction performed by the model deployed at each target terminal for a corresponding application scenario of the each target terminal may be improved.

The computer program product contains a computer program that implements the method shown in the first aspect of the present disclosure when executed by a processor.

Different from a related art in which a model is trained well on a server side and then deployed to various terminal devices for application so that the model actual applied at each of the terminal devices is the same, the computer program product provided by the embodiments of the present disclosure is implemented to determine a target pre-trained model and perform an unsupervised training and/or a semi-supervised training on the target pre-trained model based on an image acquired by the target terminal, so as to obtain a first target trained model. That is, the unsupervised training and/or the semi-supervised training are/is performed on the target pre-trained model deployed at the target terminal based on the image acquired by the target terminal, so as to obtain the first target trained model actually applied at the target terminal. Therefore, models actually applied at various target terminals are different, where each of the models is trained by using corresponding images acquired by a corresponding target terminal, so that an accuracy of a model prediction performed by the model deployed at each target terminal for a corresponding application scenario of the each target terminal may be improved.

FIG. 4 shows a schematic block diagram of an exemplary electronic device 400 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 4, the electronic device 400 may include a computing unit 401, which may perform various appropriate actions and processing based on a computer program stored in a read-only memory (ROM) 402 or a computer program loaded from a storage unit 408 into a random access memory (RAM) 403. Various programs and data required for the operation of the electronic device 400 may be stored in the RAM 403. The computing unit 401, the ROM 402 and the RAM 403 are connected to each other through a bus 404. An input/output (I/O) interface 407 is further connected to the bus 404.

Various components in the electronic device 400, including an input unit 406 such as a keyboard, a mouse, etc., an output unit 407 such as various types of displays, speakers, etc., a storage unit 408 such as a magnetic disk, an optical disk, etc., and a communication unit 409 such as a network card, a modem, a wireless communication transceiver, etc., are connected to the I/O interface 405. The communication unit 409 allows the electronic device 400 to exchange information/data with other devices through a computer network such as the Internet and/or various telecommunication networks.

The computing unit 401 may be various general-purpose and/or special-purpose processing components with processing and computing capabilities. Some examples of the computing unit 401 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 401 may perform the various methods and processes described above, such as the method of training the model. For example, in some embodiments, the method of training the model may be implemented as a computer software program that is tangibly contained on a machine-readable medium, such as the storage unit 407. In some embodiments, part or all of a computer program may be loaded and/or installed on the electronic device 400 via the ROM 402 and/or the communication unit 409. When the computer program is loaded into the RAM 403 and executed by the computing unit 401, one or more steps of the method of training the model described above may be performed. Alternatively, in other embodiments, the computing unit 401 may be configured to perform the method of training the model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, or may be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training a model, applied to a target terminal, wherein the method comprises:
determining a target pre-trained model; and
performing, by a hardware computer system, an unsupervised training and/or a semi-supervised training on the target pre-trained model based on an image acquired by the target terminal, so as to obtain a first target trained model.

2. The method of claim 1, wherein a process of training the target pre-trained model comprises a pre-training stage and a fine tuning stage.

3. The method of claim 2, wherein in the pre-training stage, a self-supervised training is performed based on a Propagate Yourself algorithm.

4. The method of claim 1, wherein the target pre-trained model is trained based on images acquired by a plurality of terminals, and at least some of the terminals are deployed in different regions respectively, and
wherein the target terminal is located in a predetermined region.

5. The method of claim 1, further comprising:
switching the target terminal from a model prediction mode to a model self-evolution mode, in response to a predetermined switch condition being met; and
performing an unsupervised training and/or a semi-supervised training on the first target trained model, so as to obtain a second target trained model.

6. The method of claim 5, wherein the predetermined switch condition comprises at least one selected from:
the target terminal failing to perform a model prediction under a current light condition; or
the target terminal failing to perform a model prediction under a current weather condition.

7. The method of claim 2, further comprising:
switching the target terminal from a model prediction mode to a model self-evolution mode, in response to a predetermined switch condition being met; and
performing an unsupervised training and/or a semi-supervised training on the first target trained model, so as to obtain a second target trained model.

8. The method of claim 3, further comprising:
switching the target terminal from a model prediction mode to a model self-evolution mode, in response to a predetermined switch condition being met; and
performing an unsupervised training and/or a semi-supervised training on the first target trained model, so as to obtain a second target trained model.

9. The method of claim 4, further comprising:
switching the target terminal from a model prediction mode to a model self-evolution mode, in response to a predetermined switch condition being met; and
performing an unsupervised training and/or a semi-supervised training on the first target trained model, so as to obtain a second target trained model.

10. An electronic device, comprising:
at least one processor; and
a memory communicatively connected to the at least one processor, wherein the memory stores instructions executable by the at least one processor, and the instructions, when executed by the at least one processor, are configured cause the at least one processor to at least:
determine a target pre-trained model; and
perform an unsupervised training and/or a semi-supervised training on the target pre-trained model based on an image acquired by the target terminal, so as to obtain a first target trained model.

11. The electronic device according to claim 10, wherein a process of training the target pre-trained model comprises a pre-training stage and a fine tuning stage.

12. The electronic device according to claim 11, wherein in the pre-training stage, a self-supervised training is performed based on a Propagate Yourself algorithm.

13. The electronic device according to claim 10, wherein the target pre-trained model is trained based on images acquired by a plurality of terminals, and at least some of the terminals are deployed in different regions respectively, and
wherein the target terminal is located in a predetermined region.

14. The electronic device according to claim 10, wherein the instructions are further configured to cause the at least one processor to:
switch the target terminal from a model prediction mode to a model self-evolution mode, in response to a predetermined switch condition being met; and
perform an unsupervised training and/or a semi-supervised training on the first target trained model, so as to obtain a second target trained model.

15. The electronic device according to claim 14, wherein the predetermined switch condition comprises at least selected from:
the target terminal failing to perform a model prediction under a current light condition; or
the target terminal failing to perform a model prediction under a current weather condition.

16. A non-transitory computer-readable storage medium having computer instructions stored therein, the computer instructions, when executed by a computer system, are configured to cause the computer system to at least:
determine a target pre-trained model; and
perform an unsupervised training and/or a semi-supervised training on the target pre-trained model based on an image acquired by the target terminal, so as to obtain a first target trained model.

17. The non-transitory computer-readable storage medium according to claim 16, wherein a process of training the target pre-trained model comprises a pre-training stage and a fine tuning stage.

18. The non-transitory computer-readable storage medium according to claim 17, wherein in the pre-training stage, a self-supervised training is performed based on a Propagate Yourself algorithm.

19. The non-transitory computer-readable storage medium according to claim 16, wherein the target pre-trained model is trained based on images acquired by a plurality of terminals, and at least some of the terminals are deployed in different regions respectively, and
wherein the target terminal is located in a predetermined region.

20. The non-transitory computer-readable storage medium according to claim 16, wherein the computer instructions are further configured to cause the computer system to:
switch the target terminal from a model prediction mode to a model self-evolution mode, in response to a predetermined switch condition being met; and
perform an unsupervised training and/or a semi-supervised training on the first target trained model, so as to obtain a second target trained model.
